(19) United States
(12) Patent Application Publication
(10) Pub. No.: US 2018/0040069 A1
(43) Pub. Date: Feb. 8, 2018

(54) SYSTEM AND METHOD FOR PROVIDING FINANCE TO RECREATIONAL VEHICLE FROM AN INVESTOR TO PLURALITY OF TRAVEL COMPANION GROUP

(71) Applicant: Marvin D. Elam, JR., Dale, TX (US)

(72) Inventor: Marvin D. Elam, JR., Dale, TX (US)

(73) Assignee: Marvin D. Elam, JR., Dale, TX (US)

(21) Appl. No.: 15/228,683

(22) Filed: Aug. 4, 2016

(51) Int. Cl. G06Q 40/06; G06Q 40/02

(52) U.S. Cl. CPC G06Q 40/06; G06Q 40/025

(57) ABSTRACT

Disclosed is a system and method for providing finance to recreational vehicle from investor to plurality of travel companion groups based upon a pre-defined criteria over a communication network. The system includes a database and a processing unit. The processing unit performs a process which includes step of determining set number of ownership weeks to be sold in each recreational vehicle by investor. Then each week sold is equivalent to actual percentage of ownership of travelling companion group. The processing unit performs a process which includes step of computing first price of the recreational vehicle per year by dividing the number of years financed by retail price of recreational vehicle. Then, computing second price of recreational vehicle per week by dividing the computed first price per year by number of ownership week sold in each recreational vehicle. Thereafter, computing third price of recreational vehicle per month by dividing computed second price per week by twelve.

### TECHNICAL FIELD

The presently disclosed embodiments are related, in general, to a system for financing recreational vehicles. More particularly, the presently disclosed embodiments are related to a system and method for providing finance to recreational vehicle from investor to plurality of travel companion groups based upon a pre-defined criteria over a communication network.

### BACKGROUND

The Recreational vehicle (RV) industry is one that thrives only when the economy thrives. During a recession or economic crisis, this industry always hit rock bottom and then the RV industries have to try new product features to dig their way out such as luxury touches, new technology such as flat screens, Wi-Fi, Led interior lighting or fuel efficiency. However, none of these recreational vehicles or motorhomes comes cheap especially the high-end luxury diesel pushers.

Today's typical RV owner is 49 years old and married, with an annual income of $68,000—higher than the median for all households according to a study by the University of Michigan's Survey Research Center, The price of a motorhome is out of reach for millions in the American economic system as the middle class shrinks further as more fall out instead of climbing up.

The RV industry has always been limited to a certain income class. There are multiple income levels that can not afford a typical Class A motorhome. According to the Census Bureau 462 million people—about 15 percent of the US population—currently live below the poverty line or the income level needed to make a bare-essentials living in the United States. This income level makes about $23,050 for a family of four. The next level of income is the middle class. Even as the American middle class has shrunk, it still has 53 million households, which is about 43 percent of all households.

There are fractional ownership program companies that attempt to make RV vacations cheaper than outright ownership, but they do not even come close in terms of affordability. The only alternative to put people into an RV cheaper right now is what they call fractional ownership. The cost is too much for the average person.

Therefore, there is a need of a system and a method to make luxury motorhomes affordable to the all family households below the median income level. Further there is also a need to provide a system and method to promote the sale of the recreational vehicle without a credit check.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to embodiments illustrated herein, there may be provided a system for providing finance to one or more recreational vehicles from one or more investors to a plurality of travel companion groups based upon, a pre-defined criteria over a communication network. The system includes a database and a processing unit. The database stores one or more instructions pertaining to the finance of the recreational vehicle, and information pertaining to the plurality of travel companion groups.

The processing unit cots pled with the database. The processing unit configured to execute one or more instructions stored in the database. In one embodiment, the processing unit performs a process which includes the step of determining a set number of ownership weeks to be sold in each recreational vehicle by the investor. In one embodiment, the each week sold is equivalent to an actual percentage of ownership of a traveling companion group. Further, the processing unit performs a process which includes the step of computing the first price of the recreational vehicle per year by dividing the number of the years financed by the retail price of the recreational vehicle.

Furthermore, the processing unit performs a process which includes the step of computing the second price of the recreational vehicle per week by dividing the computed first price per year by the number of ownership weeks sold in each recreational vehicle. The processing unit performs a process which includes the step of computing the third price of the recreational vehicle per month by dividing the computed second price per week by twelve.

These and other features and advantages of the present disclosure may be along with the accompanying figures in which like reference numerals refer to like parts throughout.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 illustrates a system environment for providing finance to one or more recreational vehicles from investor to plurality of travel companion groups based upon a pre-defined criteria over a communication network in which various embodiments of the system and the method are implemented; and

FIG. 2 illustrates a flow chart of method for providing finance to one or more recreational vehicles from one or more investor to plurality of travel companion groups based upon a pre-defined criteria over a communication network, in accordance with a preferred embodiment of the invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes as the apparatuses, methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,”“at least one embodiment,” “an embodiment” “one example,” “an example,” “for example,” and so on indicate that the embodiment(s) or example(s) may include a particular feature, structure, characteristic, property, service element, or limitation but that not every embodiment or example necessarily includes that particular feature, structure, characteristic, property, service, element, or limitation. Further, repeated use of the phrase “in an embodiment” does not necessarily refer to the same embodiment.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only. Those skilled in the art will envision many other possible variations within the scope of the technology described herein.

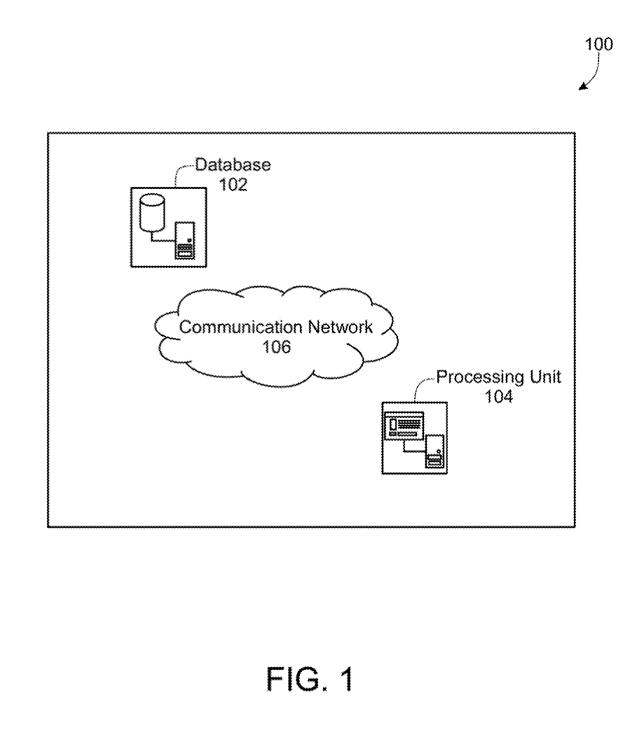

FIG. 1 illustrates a system environment 100 for providing finance to one or more recreational vehicles from investor to plurality of travel companion groups based upon a pre-defined criteria over a communication network 106 in which various embodiments of the system and the method are implemented. The system includes a database 102 and a processing unit 104. The database 102 stores one or more instructions pertaining to the finance of the recreational vehicle, and information pertaining to the plurality of travel companion group.

In an embodiment, the processing unit 104 communicates with the database 102 using one or more protocols such as, but not limited to, Open Database Connectivity (ODBC) protocol and Java Database Connectivity (JDBC) protocol. The database 102 is realized through various technologies such as, but not limited to Microsoft® SQL Server, Oracle®, IBM DB2®, Microsoft Access®, PostgreSQL®, MySQL® and SQLite®, and the like.

The processing unit 104 configured to execute one or more instructions stored in the database In one embodiment, the processing unit 104 performs a process which includes the step of determining a set number of ownership weeks to be sold in each recreational vehicle by the investor. In one embodiment, the each week sold is equivalent to an actual percentage of ownership of a traveling companion group. Further, the processing unit 104 performs a process which includes the step of computing the first price of the recreational vehicle per year by dividing the number of the years financed, by the retail price of the recreational vehicle.

Furthermore, the processing unit 04 performs a process which includes the step of computing the second price of the recreational vehicle per week by dividing the computed first price per year by the number of ownership weeks sold in each recreational vehicle. The processing unit 104 performs a process which includes the step of computing the third price of the recreational vehicle per month by dividing the computed second price per week by twelve.

In an embodiment, the processing unit 104 refers to a computing device or a software framework hosting application or a software service. In an embodiment, the processing unit is implemented to execute procedures such as, but not limited to, programs, routines, or scripts stored in one or more memories for supporting the hosted application or the software service. Java Language, HTML, and other high-level computer language can also be used. In an embodiment, the hosted application or the software service is configured to perform one or more predetermined operations.

The processing unit 104 comprises suitable logic, circuitry, interfaces, and/or code that is operable to execute a set of instructions stored in the data base 102. The processing unit 104 is implemented based on a number of processor technologies known in the art. Examples of the processing unit 104 include, but not limited to, an X86-based processor, a Reduced Instruction Set Computing (RISC) processor, an Application-Specific Integrated Circuit (ASIC) processor, a Complex Instruction Set Computing (CISC) processor, and/or other processor.

In an embodiment, the communication network 106 includes a medium through which the database 102, and the processing unit 104 communicate with each other. Such a communication is performed, in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11 802.16, 2G, 3G, 4G cellular communication protocols, and/or Bluetooth (BT) communication protocols. The communication network 106 includes, but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN).

Examples of the recreational vehicle (RV) includes but not limited to motorhome or motor coach. These vehicles are self-propelled recreational vehicle or RV which offers living accommodation combined with a vehicle engine.

The present system uses travel companions within travel companion groups, to create individual cost and investing incentives, in an all-inclusive maintenance program, to promote the sale of an item, such as a motorhome, to multiple individuals. Traveling together, while sharing expenses in an investment, for the term of a loan comprising the steps of includes an all-inclusive maintenance program for the term of the loan, individual travelers or buyers that agree to travel or vacation together. And formed into multiple member buyer groups, includes a free fuel allowance for buyer groups, on each ownership trip, for the term of the loan, and includes a group within a buyer group system.

That increases the number of buyers and reduces overall expenses for each individual buyer. Included in the retail price of the motorhome is an estimated, all-inclusive maintenance cost, a pre-determined fuel cost, and an investor's rate of return, all for the entire term of a financed loan, the rate of return, is used as an incentive, to entice investors to purchase motorhomes for the buyer groups, the investor may be a bank, a dealer a manufacturer, private investor, investment groups, a buyer group, a buyer group member or a multiple of different investors etc. a pre-determined number of ownership weeks to be sold in each motorhome is set by dealer or investor, includes an ecosystem, where each week sold in the motorhome. This will equal to a percentage of ownership in that motorhome.

The total cost of the bundled expense package, is divided by the number of financed years to get a flat cost per year, the flat cost per year is divided by the number of pre-determined weeks sold in each motorhome. Further, to get the sale price per ownership week, the price of each ownership week, is divided by 12 months. Furthermore, to get a flat monthly payment amount is divided by the number of individual members in each buyer group to get each member's monthly payment share all buyers groups are entered into a large congregated traveler/buyer group pool of potential owners, all groups pay a non-refundable deposit or down payment, to become vested and also to serve as honest money.

Additionally, multiple vested buyer groups are always left in the hole or buyer's pool, before one will move from the buyer's pool to a sold status, all buyers must agree to an authorization of automatic bank debit payments because of the no credit check privilege there is a sales referral program offered for owners to earn even more fuel than the dealers program allowance the entire method and system can be automated and used to sale motor homes over the internet or web and ownership weeks can be bought for annual or bi-annual use.

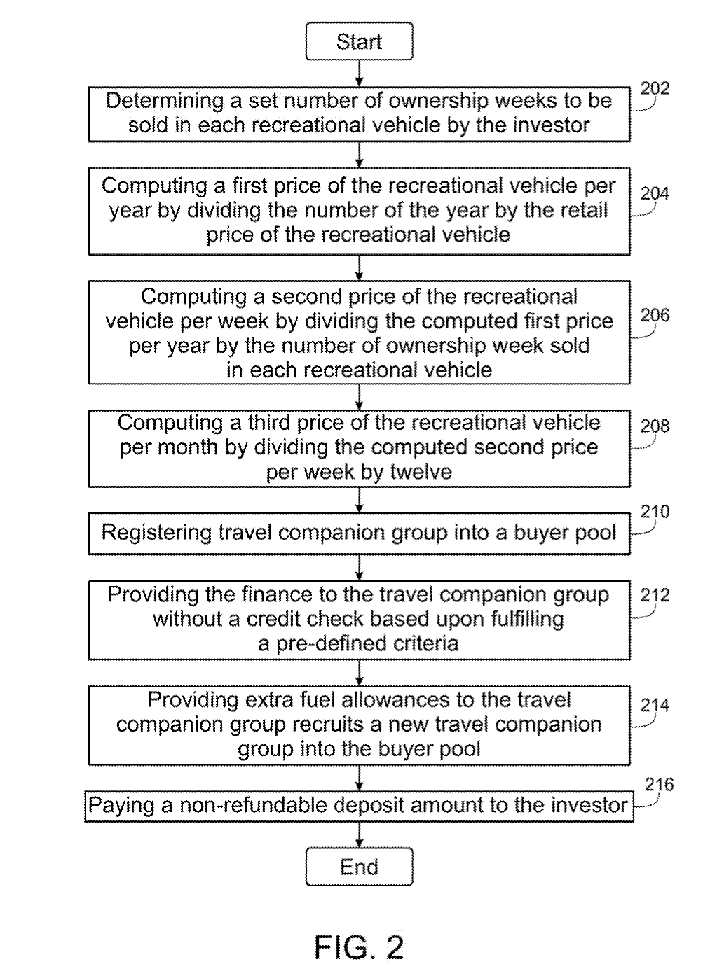

FIG. 2 illustrates a flow chart of method for providing finance to one or more recreational vehicle from one or more investors to plurality of travel companion group based upon a pre-defined criteria over a communication network in accordance with a preferred embodiment of the invention. The flowchart 200 is described in conjunction with FIG. 1. The method starts at step 202.

At step 202, determining a set number of ownership weeks to be sold in each recreational vehicle by the investor. In one embodiment, the each week sold is equivalent to an actual percentage of ownership of a travelling companion group. At step 204, computing a first price of the recreational vehicle per year by dividing the number of the years financed by the retail price of the recreational vehicle. At step 206, computing a second price of the recreational vehicle per week by dividing the computed first price per year by the number of ownership week sold in each recreational vehicle. At step 208, computing a third price of the recreational vehicle per month by dividing the computed second price per week by twelve.

At step 210, registering travel companion groups into a buyer pool. At step 212, the investor providing the finance to the travel companion group without a credit check based upon fulfilling a pre-defined criteria. In one embodiment, the pre-defined criteria is selected from at least one of: an estimated all-inclusive maintenance expense, a rate of return determined by investor, and trip fuel allowances for the term of the finance.

The investor is selected from at least one of: a dealer, a bank, a manufacturer, and a private investor. At step 214, providing extra fuel allowances to the travel companion group that recruits a new travel companion group into the buyer pool. At step 216, paying a non-refundable deposit amount to the investor.

A person skilled in the art will understand that the recreational vehicle is described herein for illustrative purposes and should not be construed to limit the scope of, the disclosure. Various embodiments of the disclosure encompass numerous advantages including systems, and methods for reducing force per unit area applied on an arm from the plurality of arms in event of collision.

Thus, the present invention provides a RV market for millennia's, the largest generation in the US Pew Research Center broken down estimates released by the US Census Bureau classifying as millennia's, everyone who was 18 to 34 years old in 2015. By that definition there are now 75.4 million living millennia's and this group does not fit the current RV owner profile. Therefore, the present system and method prompts the sale of a motor home and makes it affordable for everyone.

For example, $400,000 luxury motor home and put it into the present system. Step 1: $400,000+$250,000+$250,000 (plus maintenance and fuel/investor allowance)=$900,000. Step 2: financed for 10 years=$90,000 per year. Step 3: take 44 ownership weeks and divide this into $90,000=$2045 per ownership week.

Step 4: $2045 divided by 12=$170.00 per month payment for 1 week in $400,000 RV and the money is going toward ownership. To lease this same RV for 1 week would cost from $6000 to $8000. Step 5: a buyer group of 10 travel companions=$17.00 per month each and the biannual Cost=$8.50 per month each. A single independent adult traveling or vacationing with other family members or friends.

In the RV industry, there is nothing that comes close to this program in terms of cost or affordability and the one payment convenience. This also equates to a Free Vacation, because the monthly payment is going toward ownership, and there is a fuel allowance provision with an all-inclusive maintenance provision for the term of the loan.

A non-transitory computer readable storage medium including instructions that, when executed by a processing unit. The non-transitory computer readable storage medium cause the processing unit to perform operations comprising determining a set number of ownership weeks to be sold in each recreational vehicle by the investor. In one embodiment, the each week sold is equivalent to an actual percentage of ownership of a traveling companion group.

The non-transitory computer readable storage medium further comprising the step of computing a first price of the recreational vehicle per year by dividing the number of the years financed, by the retail price of the recreational vehicle. The non-transitory computer readable storage medium further comprising the step of computing a second price of the recreational vehicle per week by dividing the computed first price per year by the number of ownership week sold in each recreational vehicle.

Further, the non-transitory computer readable storage medium comprising the step of computing a third price of the recreational vehicle per month by dividing the computed second price per week by twelve. The non-transitory computer readable storage medium further includes the step of registering travel companion groups into a buyer pool. The non-transitory computer readable storage medium further includes the step of providing extra fuel allowances to the travel companion group which recruits a new travel companion group into the buyer pool. The non-transitory computer readable storage medium further includes the step of paying a non-refundable deposit amount to the investor, wherein the non-refundable deposit amount serve as vested amount.

Advantages of the present system and method includes but not limited to various investing incentives, a higher sales profit margin, an upfront sale of the motorhome, an investor's purchase for potential owners, dealer or private investor financing, a dealer or investor sales management program, an increase in the number of owners in a single unit, multiple travel companions, buyer incentives for the term of a loan, an all-inclusive maintenance program, dealer or investor maintenance profits, affordable individual ownership in high end units, maximum dealer or investor sales profits, a no credit check finance provision for buyers, a no credit check protection backup system, a fuel allowance for each owner trip, a built in fuel allowance, different price ranges to accommodate various budgets, family togetherness and cost savings on trips or vacations, removes the hassle of buying outright, promotes sales of motorhomes by reducing overall individual ownership cost, bi-annual ownership, a maintenance provision after the loan term, a free extra fuel referral program for owners, an investor's rate of return already built in, better than average industry loan interest rate, a fair usage policy among owners.

A person with ordinary skills in the art will appreciate that the methods, systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different apparatuses, systems or applications

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope, Therefore it is intended that the present disclosure not be limited to the particular embodiment disclosed, but that the present disclosure will include all embodiments falling within the scope of the appended claims.

1. A system for providing finance to one or more recreational vehicles from one or more investors to a plurality of travel companion groups based upon a pre-defined criteria over a communication network, the system comprising:
at least one database for storing: one or more instructions pertaining to the finance of the recreational vehicle, and information pertaining to the plurality of travel companion group; and
at least one processing unit coupled with the database, the processing unit configured to execute one or more instructions stored in the database, wherein processing unit performs a process comprising the steps of:
determining a set number of ownership weeks to be sold in each recreational vehicle by the investor, wherein the each week sold is equivalent to an actual percentage of ownership of a travelling companion group;
computing a first price of the recreational vehicle per year by dividing the number of the years financed by the retail price of the recreational vehicle;
computing a second price of the recreational vehicle per week by dividing the computed first price per year by the number of ownership weeks sold in each recreational vehicle; and
computing a third price of the recreational vehicle per month toy dividing the computed second price per week by twelve.

2. The system according to claim 1 further comprising the step of: registering travel companion group into a buyer pool.

3. The system according to claim 1 wherein the investor providing the finance to the travel companion group without a credit check based upon fulfilling a pre-defined criteria, wherein the pre-defined criteria is selected from at least one of: an estimated all-inclusive maintenance expense, a rate of return determined by investor, and trip fuel allowances for the term of the finance.

4. The investor according to claim 1 is elected from at least one of: a dealer, a bank, a manufacturer, and a private investor.

5. The system according to claim 1 further comprising the step of: providing extra fuel allowances to the travel companion group which recruits a new travel companion group into the buyer pool.

6. The system according to claim 1 further comprising the step of: paying a non-refundable deposit amount to the invest wherein the non-refundable deposit amount serve as vested amount.

7. A method for providing finance to one or more recreational vehicle from one or more investor to plurality of travel companion group based upon a pre-defined criteria over a communication network, the method comprising step of:
determining a set number of ownership weeks to be sold in each recreational vehicle by the investor, wherein the each week sold is equivalent to an actual percentage of ownership of a travelling companion group;
computing a first price of the recreational vehicle per year by dividing the number of the years financed by the retail price of the recreational vehicle;
computing a second price of the, recreational vehicle per week by dividing the computed first price per year by the number of ownership week sold in each recreational vehicle; and
computing a third price of the recreational vehicle per month by dividing the computed second price per week by twelve.

8. The method according to claim 7 further includes the step of registering travel companion group into a buyer pool.

9. The method according to claim 7 wherein the investor providing the finance to the travel companion group without a credit check based upon fulfilling a pre-defined criteria, wherein the pre-defined criteria is selected from at least one of: an estimated all-inclusive maintenance expense, a rate of return determined by investor, and trip fuel allowances for the term of the finance.

10. The investor according to claim 7 is selected from at least one of: a dealer, a bank, a manufacturer, and a private investor.

11. The method according to claim 7 further includes the step of: providing extra fuel allowances to the travel companion group recruits a new travel companion group into the buyer pool.

12. The method according to claim 7 further includes the step of: paying a non-refundable deposit amount to the investor, wherein the non-refundable deposit amount serve as vested amount.

13. A non-transitory computer readable storage medium including instructions that, when executed by a processing unit, cause the processing unit to perform operations comprising:
determining a set number of ownership weeks to be sold in each recreational vehicle by the investor, wherein the each week sold is equivalent to an actual percentage of ownership of a travelling companion group;
computing a first price of the recreational vehicle per year by dividing the number of the years financed by the retail price of the recreational vehicle;
computing a second price of the recreational vehicle per week by dividing the computed first price per year by the number of ownership week sold in each recreational vehicle; and
computing a third price of the recreational vehicle per month by dividing the computed second price per week by twelve.

14. The non-transitory computer readable storage medium according to claim 13 further includes the step of registering travel companion group into a buyer pool.

15. The non-transitory computer readable storage medium according to claim 13 further includes the step of providing extra fuel allowances to the travel companion group which recruits a new travel companion group into the buyer pool.

16. The non-transitory computer readable storage medium according to claim 13 further includes the step of paying a non-refundable deposit amount to the investor, wherein the non-refundable deposit amount serve as vested amount.
